(19) United States
(12) Patent Application Publication
(10) Pub. No.: US 2008/0140540 A1
(43) Pub. Date: Jun. 12, 2008

(54) PRICE SUBMISSION SYSTEM AND METHOD

(76) Inventor: Hugues COURCHESNE, Drummondville (CA)

Correspondence Address: OGILVY RENAULT LLP, 1981 MCGILL COLLEGE AVENUE, SUITE 1600, MONTREAL, QC, H3A2Y3, omitted

(21) Appl. No.: 11/954,632

(22) Filed: Dec. 12, 2007

Related U.S. Application Data
(60) Provisional application No. 60/869,593, filed on Dec. 12, 2006.

(51) Int. Cl. G06Q 30/00

(52) U.S. Cl. 705/26

(57) ABSTRACT

According to one embodiment of the present invention, there is described a price submission method comprising: a user entering a search query to obtain a list of at least one retailer's website; gathering an email address from the listed retailer's website using a recuperation module; sending a price query to the email address using an email server, the price query entered by the user; a retailer responding to the price query with a price submission; and transmitting the price submission to the user using a submission administration module.

### CROSS-REFERENCE TO RELATED APPLICATIONS

This patent application claims priority under 35 U.S.C. 119 of the U.S. provisional Patent Application No. 60/869,593 entitled “PRICE SUBMISSION SYSTEM AND METHOD” filed Dec. 12, 2006, which is hereby incorporated by reference.

### FIELD OF THE INVENTION

The invention relates to internet search engines, computer systems and networks, marketing, business solutions and tools for custom pricing submissions.

### BACKGROUND OF THE INVENTION

Internet search engines have the ability to list Internet website addresses according to their order of significance with respect to an item described by a keyword which is first entered by a user through an Internet search engine's web page. Some of these search engines can also generate a list of sponsored links directing to websites of sponsoring organizations which are also related to the entered keywords. For example, each time a user clicks on a listed sponsored link, the user is directed to the website of the sponsoring retailer, and the retailer pays a certain fee to the search engine provider. Occasionally, links to sponsored websites can advertise a certain price for a certain item corresponding to the keywords entered by the user. These price offers are however random in nature, and are not customized to a client's desires. As an example, a sponsored link may be listed because the website of the sponsoring organization contains a word which may be similar to a keyword entered by the user, but the sponsoring organization may not sell what the user is trying to obtain. A similar situation may occur for the other Internet website addresses listed by the search engine. From a sponsoring organization point of view, the organization may be paying without any slight guarantee that the user might be interested in making a purchase. In the present situation, it is difficult for many retailers, especially those that cannot afford sponsoring their websites, to attract potential buyers outside of their main original market, to track and study the characteristics of these buyers, and thus to easily access new markets. There is hence a need for an Internet-based pricing solution enabling a potential client to easily obtain price submissions for a specific item from a great number of listed organizations or retailers simultaneously. A method for retailers to be able to easily access different markets and potentially generate more sales should also be established.

### SUMMARY OF THE INVENTION

According to one embodiment of the invention, there is provided a fully customized method and system for a user to obtain a price submission for a specific item with specified qualifications, communicate with the retailers in order to negotiate and to possibly purchase the item through on-line payment systems or other means such as in-store or by mail and telephone.

According to an embodiment of the invention, there is provided a price submission system comprising: a recuperation module for gathering an email address of a retailer's website listed in a search result for a price query submitted by a user, the search result generated by an internet search engine; an email server for sending the price query to the retailer upon request from the user; a submission administration module for receiving a price submission from the retailer, for assuring the payment of a submission fee by the retailer, and for sending the price submission to the user; and a memory database for storing user and retailer information upon registration, as well as the search result, the price submission and the price query for consultation by the user and by the retailer.

According to another embodiment of the invention, there is provided a price submission system comprising: a recuperation module for gathering an email address from a retailer's website, having a corresponding retailer's website address resulting from a search query entered by a user; an email server for sending a price query to the email address, the price query entered by the user; and a submission administration module for transmitting a price submission to the user, the price submission sent by a retailer in response to the price query.

According to yet another embodiment of the invention, there is provided a price submission method comprising: a user entering a search query to obtain a list of at least one retailer's website; gathering an email address from the listed retailer's website; sending a price query to the email address, the price query entered by the user; a retailer responding to the price query with a price submission; and transmitting the price submission to the user.

In the description, the term “retailer” refers to anyone who sells items such as goods, products or services to the population at large or to specific markets. Retailers thus comprise particulars selling goods on Internet through their own websites or through online reselling organizations.

### BRIEF DESCRIPTION OF THE DRAWINGS

FIG. 1 is a schematic of a price submission system according to an embodiment of the invention;

FIG. 2 illustrates the price submission system of FIG. 1 in more detail, and in accordance to an embodiment of the invention;

FIG. 3 illustrates the Internet Search Engine shown in FIGS. 1 and 2 in more detail and in accordance to an embodiment;

FIG. 4 is a block diagram showing the various steps of the method in accordance to an embodiment of the invention; and

FIG. 5 illustrates how the price submission system and method enables the communication between users, retailers, and financial institutions in accordance with an embodiment of the invention.

It will be noted that throughout the appended drawings, like features are identified by like reference numerals.

### DETAILED DESCRIPTION OF A PREFERRED EMBODIMENT

The system and method described herein offers a potential client, referred to as an Internet user, the possibility to perform a search query for an item using an Internet search engine which provides a list of Internet website addresses of retailers possibly selling the specific item; to send a price query for a specific item to the listed retailers via email; receive price submissions from the retailers who responded to the price query sent to them; further negotiate with chosen retailers from the list of those who responded; and possibly buy the item from one of the retailers at the offered price using on-line services or other purchasing means. The retailers, on the other hand, receive emails, via the system, from the Internet users who previously sent price queries for a product using the system. Once the retailers verify the pertinence of the queries, they can choose to subscribe to the system. A required subscription fee can be charged to the retailers, and paid using an available on-line payment module. Once subscribed, the retailers can then reply, via the system, to the Internet user who sent the price query for which a possible sale may be achieved by further paying a submission or reply fee.

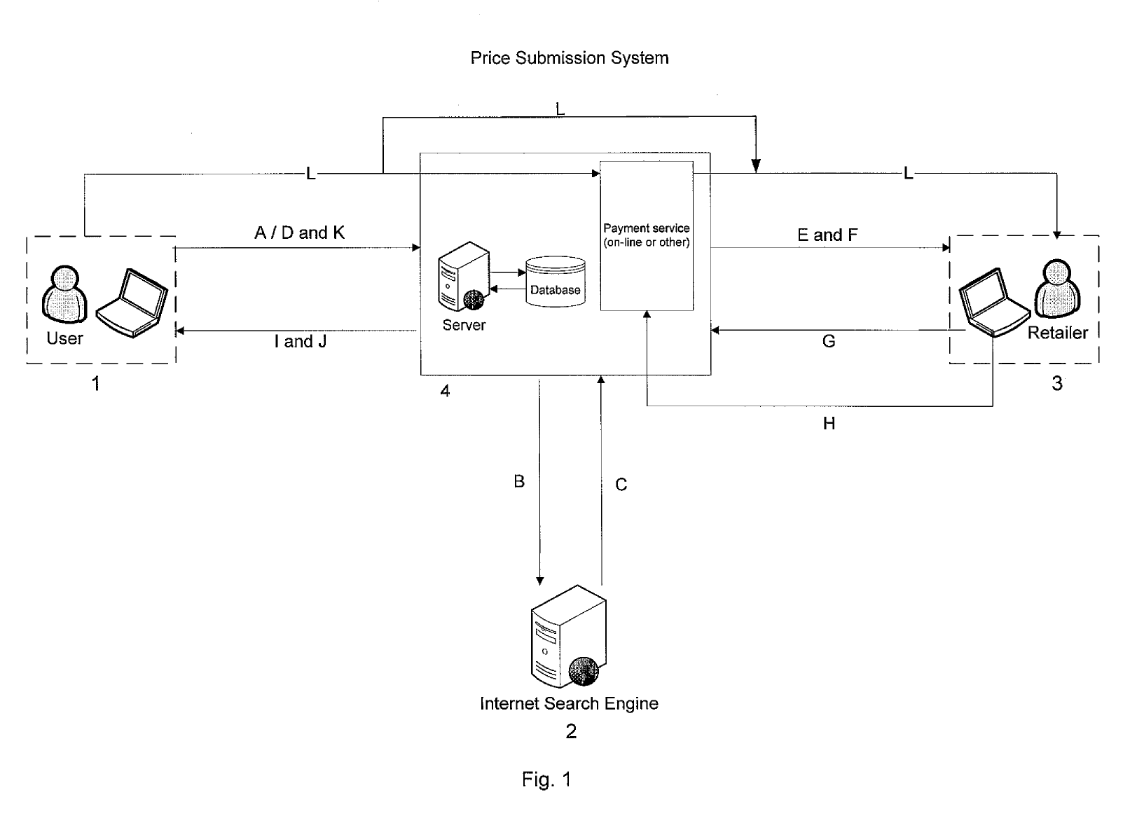

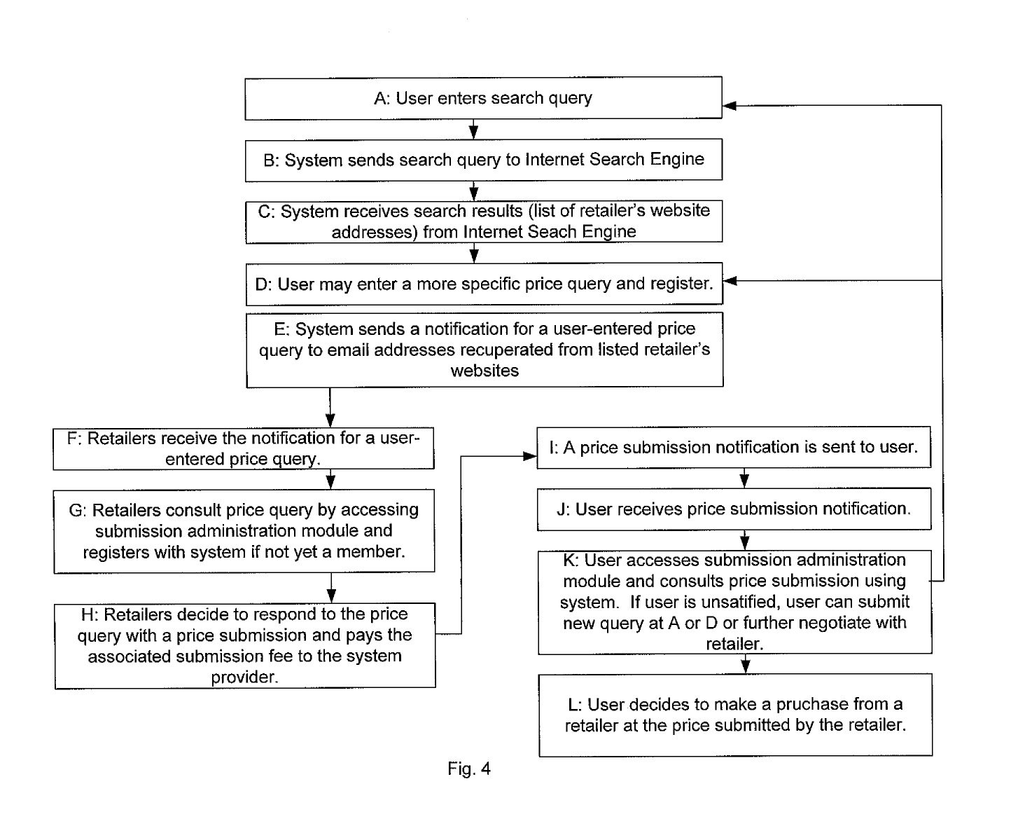

FIG. 1 fully illustrates the price submission and purchasing system 4. The letters refer to the steps of the method that is being implemented by the system 4, and according to one embodiment illustrated by FIG. 4. A user 1 enters search queries and/or price queries into the system 4. The user may enter search queries and price queries through various methods. A transcription module can be used to translate user's vocal queries captured by a microphone or a cellular phone into textual queries which are then sent to the price submission system. The system 4 works conjointly with a Search Engine 2 to obtain lists of retailers' website addresses or any link relevant with the enter search query, and recuperates the email addresses of all relevant retailers from their respective websites. The user 1 may then send a specific entered price query to all the relevant retailers at once via email. A price query can be so specific as to include a detailed description of the item desired, such as product specifications, quality, color, size, performance, origin, ingredients. Alternatively, if the item consists of a service, the price query can described what kind of service the user needs, such as coaching, medical assistance, counseling, cleaning, etc. A retailer 3 can then respond to the received price queries with an appropriate price submission by using the system 4 and paying a submission fee. The system 4 then transmits all price submissions to the user 1, who may decide to buy the item or perform another search.

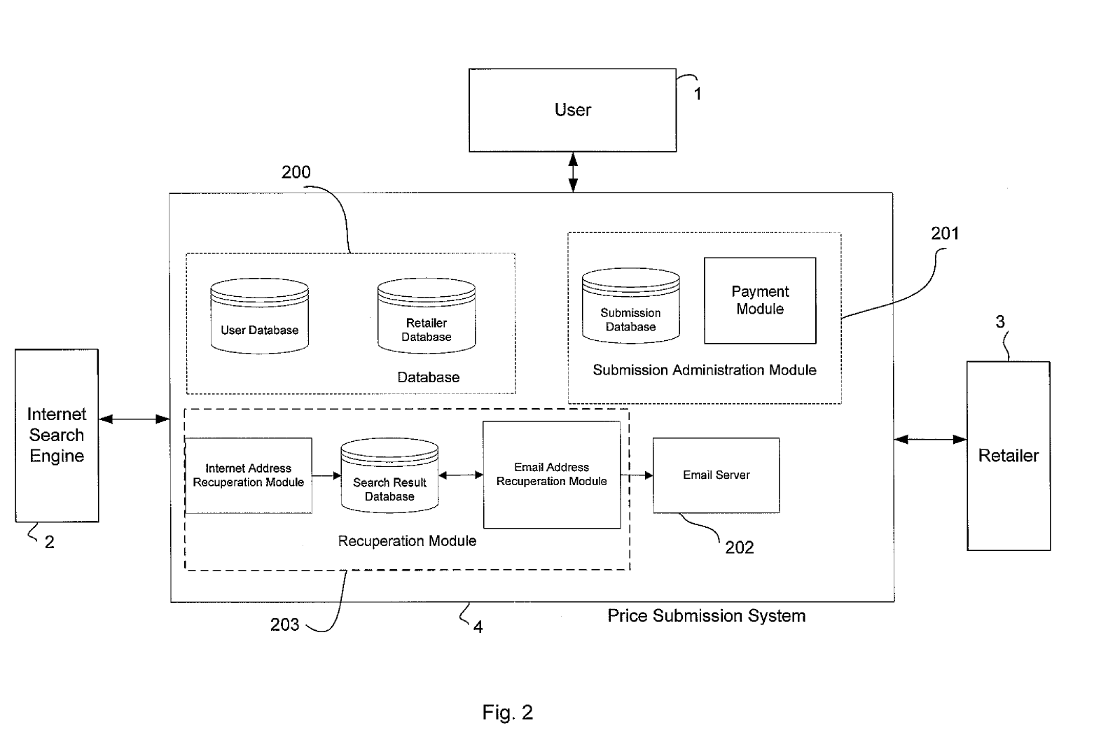

FIG. 2 illustrates the system 4 in more detail. A database 200 is used to store all relevant user and retailer information obtained when a user enters a price query or whenever a user or a retailer registers with the system. The registration process is not mandatory. A submission administration module 201 manages all price submissions sent by retailers, along with the payment of the submission fee. A recuperation module 203 such as those known to persons skilled in the art, recuperates the retailers' website addresses (URL/Internet addresses) obtained from the search query results generated by the Internet Search Engine 2. The results can be stored in a database as well, which may be within the recuperation module 203 itself or outside of this module. An email address recuperation module also forms part of the recuperation module 203 and recuperates all the email addresses found from the retailers' websites. The email server 202 can then send the price queries to the retailers' email addresses.

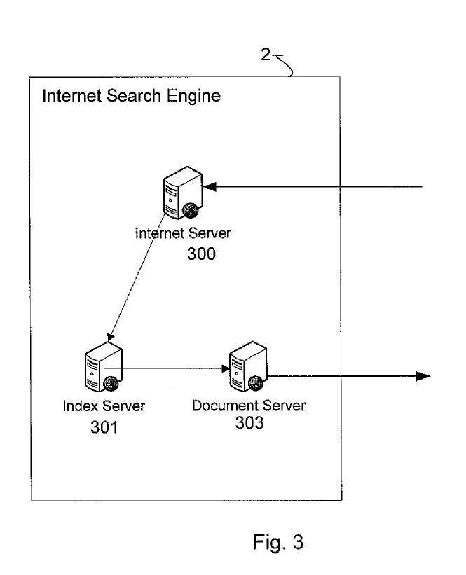

FIG. 3 illustrates the search engine 2 which receives a search query from the system 4. As an example, an internet server 300 receives the request for the search query and performs a search by communicating with an index server 301 and a document server 302. The search generates a list of relevant internet addresses which is sent to the system 4.

FIG. 4 details the method implemented by the system 4 according to a specific embodiment. In A, the user enters a search query. The system sends the search query to an Internet Search Engine 2 in step B. In C, system 4 receives the search results generated by the Search Engine 2. This includes a list of relevant retailer's website addresses. Alternatively, the user may enter a search query directly into a Search Engine's web page, which then displays a list of relevant retailer's website addresses. The user can then enter a more specific price query within the system 4 at step D such that the system may send a notification of a price query to all the retailers' email addresses at step E. Note that the retailers' email addresses are first recuperated from the retailers' web pages by the recuperation module 203. Email addresses can also be obtained and stored during a retailer's registration process, which is not mandatory. Once the retailers receive the notification of a user-entered price query at step F, they may proceed with the consultation of the price query by accessing the submission administration module 201 of the system 4 at step G, and register if they are not yet a member and wish to become one. Registration permits the entrance of more information such as a different email address into the system, and may be promoted by giving certain advantages and prizes for example. Retailer registration information is stored in a database 200 and a registration fee may be demanded. At step H, the retailers decide to respond to the price query with a price submission which is also stored for later consultation. This requires the payment of a submission fee to the system provider and via a payment module within the system or, alternatively, from an online payment service. The price queries may alternatively be displayed directly on the notification email sent to the retailers, and registration may be done upon payment of the submission fee if the retailer decides to respond. At step I, a price submission notification is sent to the corresponding user, who receives this notification at step J, and consults the submission administration module 201 of the system 4 at step K to review all price submissions and lists of retailers. The user may decide to enter preferences into the system such that only retailers within a certain geographical area are notified and displayed. If the user is unsatisfied with the received submissions, new price and search queries may be performed by returning to either of steps A or D. If the user is satisfied, a purchase may be made at step L, directly from the retailer by in-store or telephone purchase for example, or through the system 4, and using any online payment services, or possibly from the retailer's website online purchasing system.

Further particularities of the method and system described are described hereinbelow. According to an alternate embodiment, step A can take the form of step D described above, as the user 1 may first enter a price query for a specified item: a key word or a key sentence describing the item, his or her email address or contact information such as a telephone number or a mailing address, and perhaps a specific price request or range of prices. All user-entered information, including all queries, is stored in a database 200. In step B, the key words or key sentence entered by the user are sent by the system 4 to a search engine 2 which generates a list of internet addresses of retailers possibly selling an item similar to the one described by the user 1 in the price query. In step C, the system 4 gathers all the internet addresses generated by the search engine 2 and stores them in a memory device. Jumping to step E of FIG. 4, the system 4 then sends emails to all the email addresses corresponding the gathered internet addresses to inform the retailer 3 that a user 1 requires a price for the H specified item. Once steps F and G are done, the retailer decides to respond to a price query received and thus pays the submission fee necessary to reply to the user 1 in step H. Again in step H, the retailer 3 sends a reply to the user 1, through the system 4, and offers the item at a certain price to possibly make a sale. The system 4 then transmits the price submission response to the user 1, as described in step I. Upon consideration of the replies received at step K, the user then possibly decides to buy the product at the offered price in step L. The retailer 3 then receives the payment of the item and sends to purchased item to the user.

According to another embodiment, when an internet user 1 performs a search for an item at step A by entering a search query, the user can do so by directly using a search engine 2. Once the search is performed and the list of relevant retailers' websites is displayed (steps C), the internet user has the possibility to click on a specific link for getting a price for that same item along with further specifications (step D: this user-entrance is referred to as a price query), and from the commercial retailers listed in the search result. Hence, when the user clicks on this link, another window or same window opens asking the user to enter his email address and a possibly more specific description of the product for which the users desires to obtain a price. The further specified product is at least related to the item originally searched for using the search engine (the price query has some relation to the first search query). Once the user clicks on the send button, the system 4 obtains all the email addresses of the URL addresses listed in the first search results, generic or sponsored, and sends the price query to all these addresses (step E). When the retailer 3 receives an email informing him that there is a potential buyer asking a price for a specific product (step F), the retailer 3 can subscribe to the system in order to reply to the potential buyer or internet user (step G) and possibly make a sale. Each time the retailer 3 answers a price query by sending an email to an internet user 1 asking for a price submission, the retailer must pay a certain fee to the provider of the system 4 (step H). Upon receipt of price offers from a list of retailers, the user may choose to proceed with the acquisition of the product from one of the retailers and at the price submitted using an on-line payment service, or to contact the retailer to negotiate. If the payment is made online, the retailer 3 then receives the information concerning the order along with the payment, and can thus send the product to the user 1.

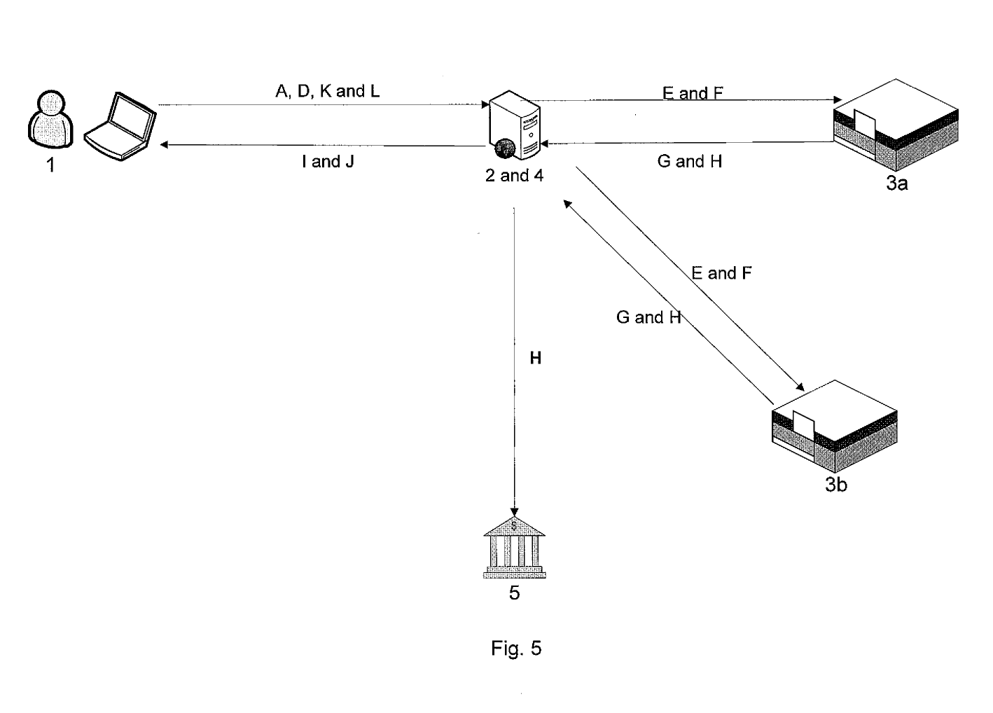

FIG. 5 illustrates how the price submission system 4 and method herein described enables the communication of more than one retailer 3a and 3b, along with a financial institution 5 for the payment of the submission fee by both retailers 3a and 3b. The fees may be pre-defined according to various criteria, and the payment can be performed each time a reply price offer is sent to a user 1, or credited from a retailer's account which may be paid on a monthly basis, for example. Any other type of rewarding or payment strategy can be implemented by the system and method described herein.

The embodiments of the invention described above are intended to be exemplary only. The scope of the invention is therefore intended to be limited solely by the scope of the appended claims.

What is claimed is:

1. A price submission system comprising:
a recuperation module for gathering an email address from a retailer's website, having a corresponding retailer's website address resulting from a search query entered by a user;
an email server for sending a price query to said email address, said price query entered by said user; and
a submission administration module for transmitting a price submission to said user, said price submission sent by a retailer in response to said price query.

2. The system as in claim 1, further comprising a memory database for storing user and retailer information, said retailer's website, said price query and said price submission.

3. The system as in claim 2, wherein said user and retailer information are entered by said user and said retailer upon registration.

4. The system as in claim 1, said submission administration module is also for charging a transmission fee to said retailer.

5. The system as in claim 1, wherein said corresponding retailer's website address is generated using an Internet search engine.

6. A price submission method comprising:
a user entering a search query into a search engine to obtain a list of at least one retailer's website;
a price submission system gathering an email address from said listed retailer's website;
said user entering a price query in said price submission system;
said price submission system sending a price query to said email address;
a retailer responding to said price query with a price submission; and
transmitting said price submission to said user.

7. The method as in claim 6, wherein said transmitting comprises charging a transmission fee to said retailer.

8. The method as in claim 6, wherein said list is generated using an Internet search engine.

9. The method as in claim 6, further comprising said user and said retailer entering registration information, said registration information for being stored in a memory database.

10. The method as in claim 6, further comprising storing at least one of said list, said price query and said price submission in a memory database.
